(19) United States
(12) Patent Application Publication
(10) Pub. No.: US 2003/0031863 A1
(43) Pub. Date: Feb. 13, 2003

(54) Easily severed adhesive tape and cutting device thereof

(76) Inventor: Shih-Chi Chen, Taoyuan (TW)

Correspondence Address: Shih-Chi Chen, P. O. Box 55-846, Taipei, 104, TW

(21) Appl. No.: 10/212,612

(22) Filed: Aug. 2, 2002

(30) Foreign Application Priority Data
Aug. 9, 2001 (TW) 90213553

(51) Int. Cl. B32B 7/12; B32B 15/04

(52) U.S. Cl. 428/343

(57) ABSTRACT

An adhesive tape prewound on a reel includes a plurality of short cutting slits equally-spaced and pre-cut in a side edge portion lengthwise of the tape; whereby upon an initial tearing of the tape from each short cutting slit, the tape will be severed easily, safely and manually without the aid of a cutting knife.

### BACKGROUND OF THE INVENTION

A conventional adhesive tape T as wound on a reel R may be unwound and cut by a cutting tool such as serrated tool S as shown in FIG. 1 for fastening use. However, the serrated teeth of the cutting tool S may easily injure the tape user, especially being dangerous or harmful for a child.

The present inventor has found the drawbacks of the conventional adhesive tape and invented the present adhesive tape which may be easily severed.

### SUMMARY OF THE INVENTION

The object of the present invention is to provide an adhesive tape wound on a reel having a plurality of short cutting slits equally-spaced and pre-cut in a side edge portion lengthwise of the tape; whereby upon an initial tearing of the tape from each short cutting slit, the tape will be severed easily, safely and manually without the aid of a cutting knife.

Another object of the present invention is to provide a cutting device for severing the adhesive tape having a plurality of short cutting slits pre-cut in a side edge portion of the tape, and having an anvil transversely held beneath the tape; whereby upon tearing of the tape from each short cutting slit of which the tape is cushioned against the anvil, the tape will be easily safely severed, without being cut by an acute knife or serrated tool.

### BRIEF DESCRIPTION OF THE DRAWINGS

FIG. 1 shows a conventional adhesive tape being cut by a serrated tool.

FIG. 2 is a perspective view of the present invention.

FIG. 3 is a top view illustration showing the angles as defined for the cutting slit of the present invention.

FIG. 4A shows a tape when improperly forming the angle of the cutting slit of the present invention.

FIG. 4B shows the unwinding of the tape following FIG. 4A.

FIG. 4C is a top view illustration of the tape as shown in FIG. 4A.

FIG. 5A shows the tape having the correct acute angle of the cutting slit in accordance with the present invention.

FIG. 5B shows the unwinding of the tape following FIG. 5A.

FIG. 5C is a top view illustration of the tape as shown in FIG. 5A.

### DETAILED DESCRIPTION

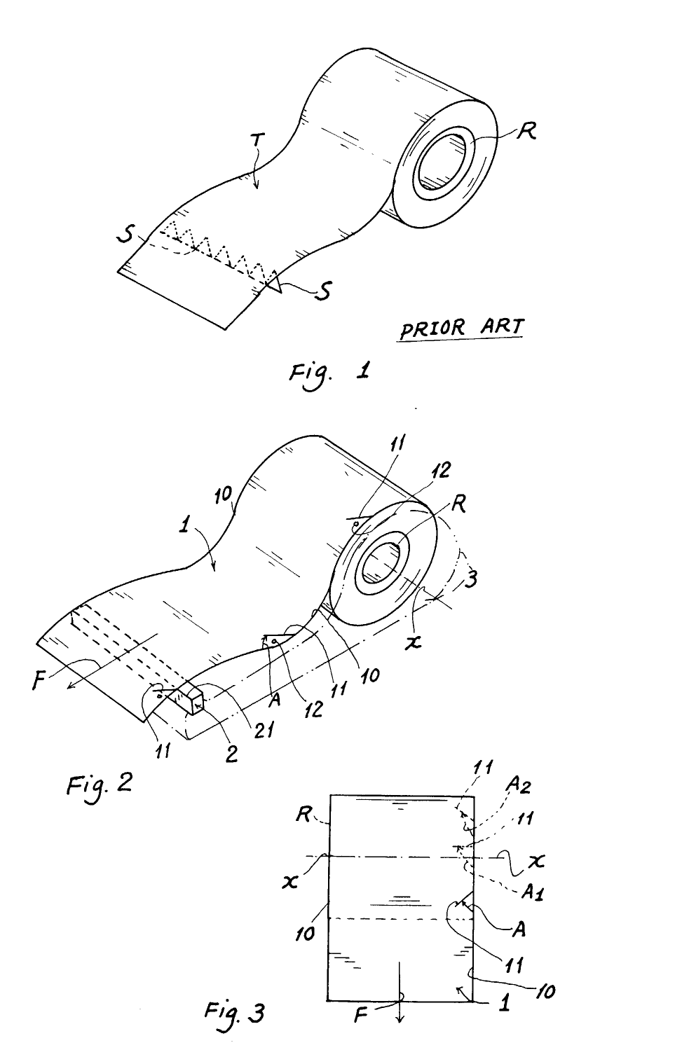

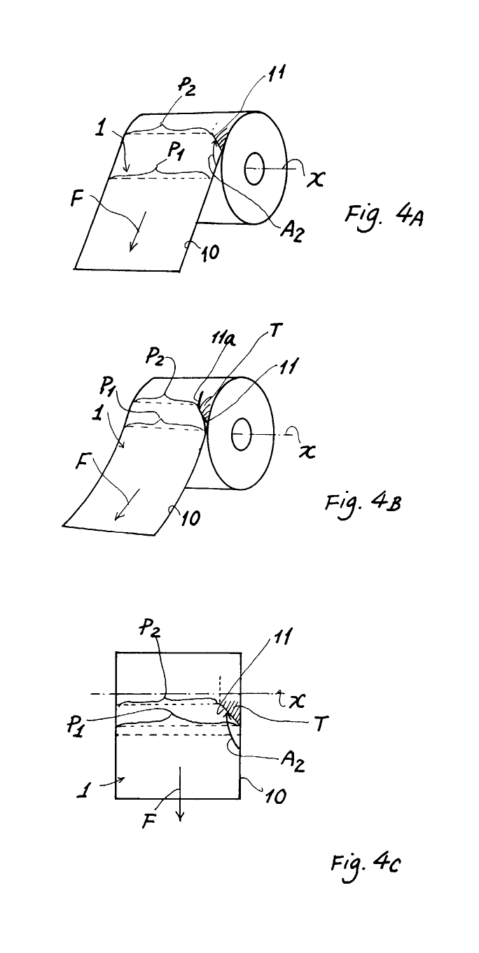

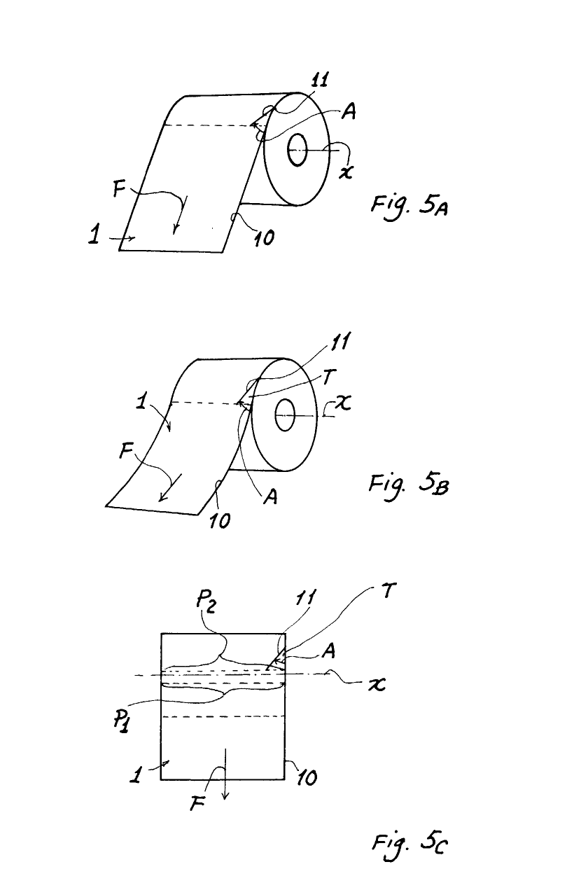

As shown in FIGS. 2 and 3, the present invention comprises: an adhesive tape 1 prewound on a reel R rotatably mounted on a tape holder 3 about an axis X, and an anvil 2 transversely formed on a front portion of the tape holder beneath the tape 1. The tape 1 defines two opposite side edge portions 10 across the width of the tape, each side edge portion 10 being projectively perpendicular to the axis X.

The adhesive tape 1 includes a plurality of short cutting slits 11 equally-spaced and pre-cut in a side edge portion 10 lengthwise of the tape 1, each short cutting slit 11 having an indicating mark 12 marked on the side edge portion 10 adjacent each cutting slit 11 for easy discovery of the cutting slit 11. However, the mark 12 is not critically necessary and may be eliminated if the cutting slit 11 is too small (or short) and the slits are densely distributed on the tape 1.

Each short cutting slit 11 defines an acute angle A as deviated from the side edge portion 10 as measured from a pulling direction (F) distal from the axis X of the reel R.

As shown in dotted lines of FIG. 3, if the angle of the cutting slit 11 is not an acute angle and is a right angle A1, or obtuse angle A2, the adhesive tape 1 after being pulled by pulling force F will be incompletely torn from the reel R, easily breaking the tape to be a narrow width of the tape when pulled outwardly for use.

For instance, the tape 1 as shown in FIGS. 4A, 4B and 4c, when pulled by force F, will exert a pressure P1 across the width of the tape 1 before the cutting slit 11. After further pulling (tearing) of the tape 1 at or beyond the cutting slit 11 of obtuse angle A2, the “triangular tape portion” T is still adhered on the tape reel and the pulling force F will then “focus” on the narrower width (smaller cross sectional area of the tape) to increase the pressure to be P2. The tape will then be torn at the “breaking point” along the slit 11a (FIG. 4B) to release an incomplete (narrower width) tape. That is to say that when the tape is released from the tape reel R just under pulling tension and not reaching the desired length, the tape may be unexpectedly broken at a cutting slit 11 to thereby influence the cutting or use of the tape.

Comparatively, reviewing the acute angle A of the cutting slit 11 as defined by the present invention as illustrated in FIGS. 5A, 5B and 5C, the first pressure P1 before the cutting slit 11 and the second pressure P2 beyond the cutting slit 11 (FIG. 5C) are generally equal each other since the cutting slit 11 is inclined inwardly sidewardly towards the side edge portion 10 in a direction opposite to the pulling force F, having the “triangular tape portion” T also protruding inwardly sidewardly towards the side edge portion 10 in a direction opposite to the direction of pulling force F.

The anvil 2 may be formed as a rod member, a column or a bar transversely formed on a front portion of the tape holder beneath the tape 1 having at least an angular block portion 21 transversely formed on the anvil 2; whereby upon cushioning of the tape 1 having the short cutting slit 11 positioned at the side edge portion 10 of the tape 1 against the angular block portion 21 of the anvil 2, the tape 1 will be easily ergonomically torn from the cutting slit 11 and then quickly transversely severed across the tape for its end use.

The anvil 2 does not require an acute cutting edge, knife edge or serrated edge to thereby prevent from being injured by such an acute edge.

The tape 1 may also be easily conveniently severed as initially tearing from the cutting slit 11 without the aid of the anvil 2 as shown in FIG. 2. It means that the tape 1 of the present invention may be directly manually severed without any knife or cutting tool.

The present invention may be modified without departing from the spirit and scope of the present invention.

I claim:

1. An adhesive tape device comprising:
an adhesive tape prewound on a reel rotatably mounted on a tape holder about an axis, and an anvil transversely formed on a front portion of the tape holder beneath the tape;
said adhesive tape having two opposite side edge portions across a width of the tape, each said side edge portion being projectively perpendicular to the axis; said adhesive tape including a plurality of short cutting slits equally-spaced and pre-cut in one said side edge portion lengthwise of the tape, and each said short cutting slit defining an acute angle as deviated from one said side edge portion as measured from a pulling direction distal from the axis of the reel when outwardly pulling or tearing the tape from the reel.

2. An adhesive tape device according to claim 1, wherein said tape further includes an indicating mark marked on the side edge portion adjacent to each said cutting slit for easy discovery of each said cutting slit.

3. An adhesive tape device according to claim 1, wherein said anvil is formed as a rod member transversely formed on a front portion of the tape holder beneath the tape having at least an angular block portion transversely formed on the anvil; whereby upon cushioning of the tape having the short cutting slit positioned at the side edge portion of the tape against the angular block portion of the anvil, the tape will be easily ergonomically torn from the cutting slit and then quickly transversely severed across the tape.

4. An adhesive tape prewound on a reel adapted to be rotatably mounted on a tape holder about an axis, said tape having two opposite side edge portions across a width of the tape, each said side edge portion being projectively perpendicular to the axis; the improvement which comprises:
said adhesive tape including a plurality of short cutting slits equally-spaced and pre-cut in one said side edge portion lengthwise of the tape, and
each said short cutting slit defining an acute angle as deviated from one said side edge portion as measured from a pulling direction distal from the axis of the reel when outwardly pulling or tearing the tape from the reel.

5. An adhesive tape according to claim 4, wherein said tape further includes an indicating mark marked on the side edge portion adjacent to each said cutting slit for easy discovery of each said cutting slit.
